(19) United States
(12) Patent Application Publication
(10) Pub. No.: US 2002/0120607 A1
(43) Pub. Date: Aug. 29, 2002

(54) File sharing system for serving content from a computer

(75) Inventors: William D. Price, San Francisco, CA (US); Terence R. Sheehy, Mountain View, CA (US); Graham P. Churchley, Palo Alto, CA (US); Andrew D. Farlie, Los Gatos, CA (US); Richard J. Walker, Los Altos, CA (US); Huzefa Karachiwala, San Carlos, CA (US); Cristian Alzati, Palo Alto, CA (US)

Correspondence Address: GARY CARY WARE & FREIDENRICH LLP, 1755 EMBARCADERO ROAD, PALO ALTO, CA, 94303-3340, US

(73) Assignee: LUMENATI, INC.

(21) Appl. No.: 09/921,193

(22) Filed: Aug. 1, 2001

Related U.S. Application Data
(60) Provisional application No. 60/272,671, filed on Feb. 28, 2001.

(51) Int. Cl. G06F 7/00

(52) U.S. Cl. 707/1

(57) ABSTRACT

The present invention effectively transforms any broadband-connected computer into a DNS addressable information publisher. The invention inverts the current server-centric web-publishing model and extends the reach of the DNS system to any user accessing the Internet. Subscribers may directly serve content from their own computers to requesting users accessing websites of the subscribers using a standard web browser interface.

The present invention relates to file sharing systems and more particularly to a file sharing system that allows individual users to serve data from their computers such that the information is freely available using a standard browser application.

### BACKGROUND OF THE INVENTION

File sharing over the Internet has recently become popular due in part to the rapidly increasing user-base, and the global publicity surrounding the music industry and its court battle with companies such as Napster. Conventional file sharing solutions typically allow a user to subscribe to a particular service that assigns a predetermined amount of storage space to that user which the user can utilize to store a wide variety of data, such as documents, pictures, music files, and the like. Access to the user's personal storage area is generally protected by a user name and password, and other users wishing to access the data must log into that user's storage area to retrieve the desired data. Other solutions involve establishing a group of members who may freely share data amongst each other simply by accessing an associated storage area for the group and posting and retrieving data files to that shared storage area. However, both conventional solutions require the user wishing to share particular files to upload the files to a central storage site, and that users wishing to retrieve those files access the central storage site, from which the various files are served to those users.

Another solution, such as Napster, allows users to share files directly from their computers, and not uploading those files to a central repository. However, special software is required by all parties wishing to retrieve shareable files using this solution. Accordingly, there is a need for a solution that allows individual users to serve data from their computers such that the information is freely available using a standard browser application. It is to this end that the present invention is directed.

### SUMMARY OF THE INVENTION

For purposes of this application, a subscriber is an end-user electing to use the software described herein to directly serve content from their personal computer. A partner is a third-party service partner of the network operator (an entity that licenses and hosts the system described therein). A guest is a user viewing a published website using a standard web browser.

The present invention effectively transforms any broadband-connected computer into a DNS addressable information publisher. The invention inverts the current server-centric web-publishing model and extends the reach of the DNS system to any user accessing the Internet. Guests, using a standard web browser interface, are able to directly view content served by subscribers′ computers.

In an aspect, the invention affords a system for facilitating information publishing over a network, comprising one or more subscriber computers connected to a server via the network. Each of the subscriber computers has a client application resident thereon for managing communication between the respective subscriber computer and the server. A console application is afforded for interacting with the server to enable the serving of information from the respective subscriber computer such that the information is accessible via a standard web browser application. Further, the server has one or more APIs residing thereon for managing end-user information received from the subscriber computers. The APIs also manage end-user information received from a managing service provider.

The client application may further comprise a presentation layer for dynamically generating a webpage that is displayed in the web browser application and has actively managed hyperlinks to the information located on the respective subscriber computers. Preferably, the presentation layer causes an away webpage to be displayed in the web browser application when the subscriber computer attempted to be accessed is offline. The availability of the information may be restricted to a community of designated individuals, and includes any of image files, movie files, audio files and documents.

The subscriber computers are preferably connected with the server in a virtual hub-and-spoke fashion, such as via the Internet, and communication between the subscriber computers and the server may be accomplished via HTTP/S over the Internet. The server comprises a subscriber module for communicating with the client application to process a variety of messages received from the client application, a guest module for processing requests originating from the web browser application, a management API module for providing a secure interface between a Service Provider and the server, and one or more daemon applications for managing communications with the subscribers and guests.

The guest module resolves a domain name to a current IP address of a subscriber computer, and monitors the subscriber computers to determine which of the subscriber computers are online, and if online, redirects a computer originating the browser request to the appropriate subscriber computer. The guest module also handles subsequent requests, such as hyperlink selections, originating from the web browser application and redirects such requests to the appropriate subscriber computer.

The daemon applications preferably handle all e-mail traffic generated by subscriber actions or management API requests, performing any of generating HTML e-mails with appropriate branding information, sending e-mail messages on behalf of a particular subscriber, generating private web site invitations, and sending e-mail notification messages.

The management API module permits the creation and management of subscriber account information. The management API module comprises an inbound API module for enabling the creation, modification, and deletion of end-user record information, an outbound API module for permitting querying of the system, a security and authentication module for authenticating communications within the system, and a guest referral tracking module for enabling the tracking of information relating to the origin of guest referrals.

The inbound API module includes a first function for creating a new end-user record, a second function for updating an end-user record, and a third function for removing an end-user record. The first function comprises a data structure having a first field for identifying a unique identifier of a partner, a second field for identifying the domain name associated with an end-user, a third field for identifying a user name associated with an end-user, a fourth field for identifying an e-mail address associated with an end-user, and a fifth field for identifying a given name of an end-user. Optionally, the data structure has a sixth field for identifying a password associated with an end-user, a seventh field for identifying a trial period timeframe, and an eighth field for determining branding and end-user ownership information. The second function comprises a data structure having a first field for identifying a unique identifier of a partner, a second field for identifying the domain name associated with an end-user, and a third field for identifying a trial period timeframe. Optionally, the data structure has a fourth field for determining branding and end-user ownership information, a fifth field for indicating whether a preferred e-mail address for an end-user has changed, a sixth field for indicating whether an account name for an end-user has changed, and a seventh field for indicating whether a password for an end-user has changed. The third function comprises a data structure having a first field for identifying a unique identifier of a partner, a second field for identifying the domain name associated with an end-user, and a third field for identifying a user name associated with an end-user. Optionally, the data structure has a fourth field for determining branding and end-user ownership information.

The outbound API module includes a first function for returning the number of registered subscribers of the system, a second function for returning the number of activated sites, a third function for returning the number of converted sites, a fourth function for returning the number of churns, and a fifth function for returning the number of invitation messages sent to one or more guests. Optionally, the outbound API module includes a sixth function for returning the average number of registered websites, a seventh function for returning the number of guests that visited particular websites, an eighth function for returning the total pages rendered from a specific website, and a ninth function for returning an accumulated amount of data served from a specific website.

The client application communicates with the console application via a software registry which permits configuration of the system and management of content. Configuration information is persisted on the subscriber computer and a portion of the configuration information is written to a configuration file associated with an instance of a server running in the subscriber computer. Preferably, the instance of a server is an instance of an Apache server. A mutex is used to notify the client application of a change in state of the registry, such that the client application responds to the notification to read the system registry and process the configuration changes.

An XML messaging scheme may be used to manage communications between the client application and the server. The XML messaging scheme includes a first message transmitted from the client application to the server for informing the server that an associated website is active, a second message for informing the server of the IP address of a subscriber computer, a third message transmitted from the client application to the server for transmitting configuration information to the server, a fourth message transmitted from the client application to the server for sending e-mail addresses of guests to whom various notification messages should be sent when a website is online, and a fifth message transmitted from the server to the client application to determine whether the client application is reachable.

### BRIEF DESCRIPTION OF THE DRAWINGS

FIG. 1 is a diagram illustrating a preferred architecture of the system;

FIG. 2 is a diagram illustrating, in more detail, the server shown in FIG. 1;

FIG. 3 is a diagram illustrating, in more detail, the management API shown in FIG. 2;

FIG. 4A illustrates operation of the inbound API shown in FIG. 3, utilizing the “AddSite” function;

FIG. 4B illustrates operation of the inbound API shown in FIG. 3, utilizing the “RemoveSite” function;

FIG. 4C illustrates operation of the inbound API shown in FIG. 3, utilizing the “ModifySite” function;

FIG. 5A illustrates an exemplary data structure for the “AddSite” function shown in FIG. 4A;

FIG. 5B illustrates an exemplary data structure for the “RemoveSite” function shown in FIG. 4B;

FIG. 5C illustrates an exemplary data structure for the “ModifySite” function shown in FIG. 4C;

FIG. 6 is a diagram illustrating an architectural view of the client application shown in FIG. 1;

FIG. 7 is a diagram illustrating a communication scheme with the imaging application shown in FIG. 6;

FIG. 8 is a diagram illustrating a mutex feature of the present invention;

FIG. 9 is an exemplary representation of a screen layout in accordance with a Simple mode option of the presentation layer shown in FIG. 1;

FIG. 10 is an exemplary representation of an away web page that may be displayed to a guest attempting to access a subscriber's website that is offline; and

FIGS. 11-13 illustrate respectively an exemplary database schema that may be used by the system to facilitate information storage.

### DETAILED DESCRIPTION OF THE PREFERRED EMBODIMENT

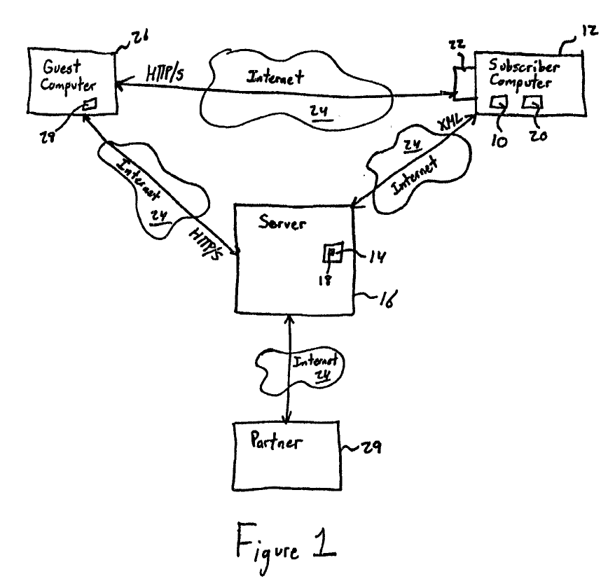

FIG. 1 is a diagram illustrating a preferred architecture of the system. The system is generally comprised of a desktop (i.e., computer) application 10 that resides on a subscriber's computer 12 together with a series of services and APIs 14 that reside on a server 16. Preferably, subscribers′ computers 12 are connected in a virtual hub-and-spoke fashion through the server 16 via the Internet. Advantageously, the server 16 is transparent to the subscribers. The computer application 10 (referred to herein as Active Node) is a persistent, lightweight client software module that manages the communication between the subscriber's computer 12 and the server 16.

One of the APIs 14 that resides on the server 16 may be a management API 18 (described in more detail below) that is a real-time interface that provides access to write, modify, delete and query end user information. It should be noted that the management API 18 deals with the creation, manipulation, and querying of end-user information, and does not support activities such as order processing, or tracking of billing events. The subscriber's computer 12 may also include a console utility (subscriber console application) 20 embodied as client software that interacts with the server 16 and enables a subscriber to activate, configure, and publish information over the network. The information may be made publicly available at large, or may be restricted to a community of designated individuals. The system also includes a presentation layer 22 that dynamically generates an HTML (or other) type webpage with actively managed hyperlinks to all of the published files and subfolders located on the subscriber's computer 12. Alternatively, subscribers may elect to provide their own webpages and may elect not to utilize the presentation layer 22.

The subscriber console application 20 is preferably a small piece of software code that is simple to install on a personal computer and runs on the desktop of the computer. Preferably, the software application 20 runs in the background and is represented by an icon in the system tray of the Windows desktop (assuming a Windows platform). The subscriber console application 20 user interface may include buttons, text boxes, and rollover text windows.

Users accessing the Internet 24 via their computers 26 (such as by using a web browser application 28) may freely view the shared data simply by using their browser 28 to access the subscriber's webpage, and may otherwise interact with that webpage as is conventionally well known to retrieve shared data therefrom. Preferably, when a subscriber's webpage is unavailable, for example, if the subscriber has shut down his or her computer 12 or disconnected from the Internet, so that the computer 12 can no longer serve content, and a user wishes to access that webpage, the system may generate a personalized “away” webpage that can be displayed to the user indicating that the requested webpage is currently unavailable rather than rendering a standard error page.

Communications between the various components of the system preferably takes place over the public Internet 24 via HTTP/S. Additionally, an XML messaging scheme is preferably used to manage all communications between the Active Node 10 and the server 16. Industry standard security techniques and digital certificates may also be employed to secure and authenticate the involved parties when transmitting sensitive information over the network 24.

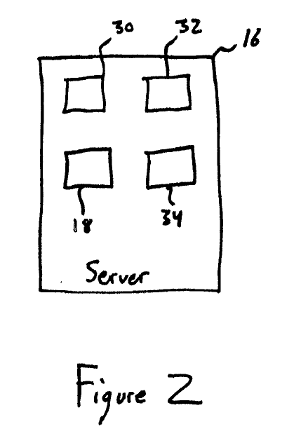

The server 16 preferably functions as a ubiquitous touch point, servicing requests from subscribers, partners, and guests using the system. The server 16 is preferably composed of different modules, which are shown in FIG. 2. In FIG. 2, the server 16 is shown comprised of four distinct modules, including a subscriber module 30, a guest module 32, a management API module 18, and daemons 34 for managing e-mail and verifying subscribers' DNS Internet connectivity, i.e., ensuring that a subscriber's domain name resolves to the server 16. The subscriber module 30 is responsible for communications with the Active Node 10. It responds to a variety of message requests as they are received from the Active Node 10 by confirming or rejecting such requests.

The guest module 32 deals with requests that originate from a guest's web browser. This includes lookups to resolve a domain name to a subscriber's current IP address. The guest module 32 also sends a message to the subscriber's machine to determine whether it is currently online and, if so, redirects the request to connect the guest directly to the subscriber's machine. If the subscriber is not currently online, the guest module 32 may render an appropriate response page to so indicate.

Subsequent requests (i.e., hyperlink selections from the guest browser) are also first handled via the guest module 32 and then redirected to the subscriber's machine. This enables, for example, a guest to bookmark a webpage on his/her own browser, since the bookmarks record only the domain name and not the IP address of a site. Because the guest module 32 handles requests, if the guest elects to revisit a bookmarked website, the guest module 32 redirects the request to the subscriber's machine at its current IP address (since the IP address of the subscriber's machine is likely to change often given that most ISPs are using the DCHP scheme). DHCP is a dynamic scheme whereby machines on the Internet are allocated IP addresses by the ISPs. It should be noted that an IP address may or may not change when reconnecting to the Internet.

The management API module 18 provides partners with a secure interface to the server 16. Through the API 18, partners can create and manage subscriber account information and inquire about active user accounts.

The e-mail and message daemons 34 are respectively responsible for sending e-mails on behalf of subscribers. The e-mail daemon 34 separates the e-mail traffic generated by the system from a subscriber's existing e-mail client. Among the tasks managed by the e-mail daemon 34, it may generate HTML e-mails with appropriate partner branding, send e-mails on the subscriber's behalf with the subscriber's preferred e-mail address in the “From” field for all outbound notices, and generate private site invitations including the site password.

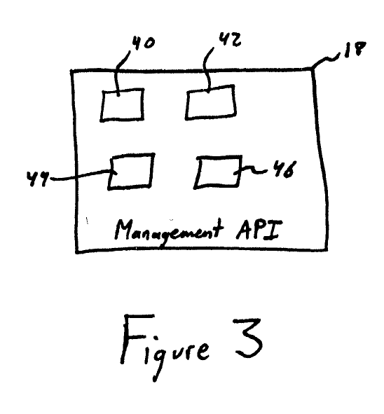

FIG. 3 is a diagram illustrating, in more detail, the management API module 18 described above. The management API module 18 may comprise multiple sub-modules, such as an inbound API 40, an outbound API 42, and security and authentication modules 44. The inbound API 40 enables partners to create, modify or delete end-user records. The outbound API 42 enables partners to query the database for information about their subscriber base as well as guest referral tracking data. The security and authentication module 44 is not itself an API, but is tightly coupled with the inbound and outbound APIs 40, 42. It addresses system security and the use of digital certificates in order to authenticate all communications between the sever 16 and the partners.

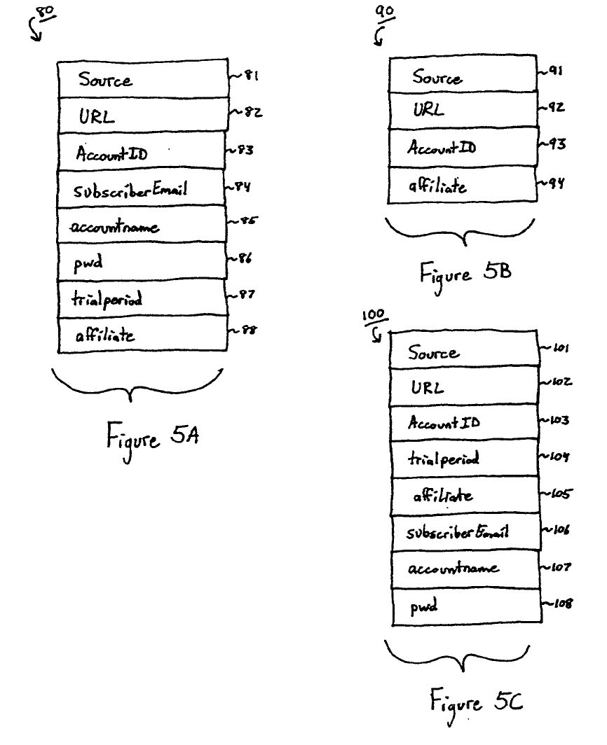

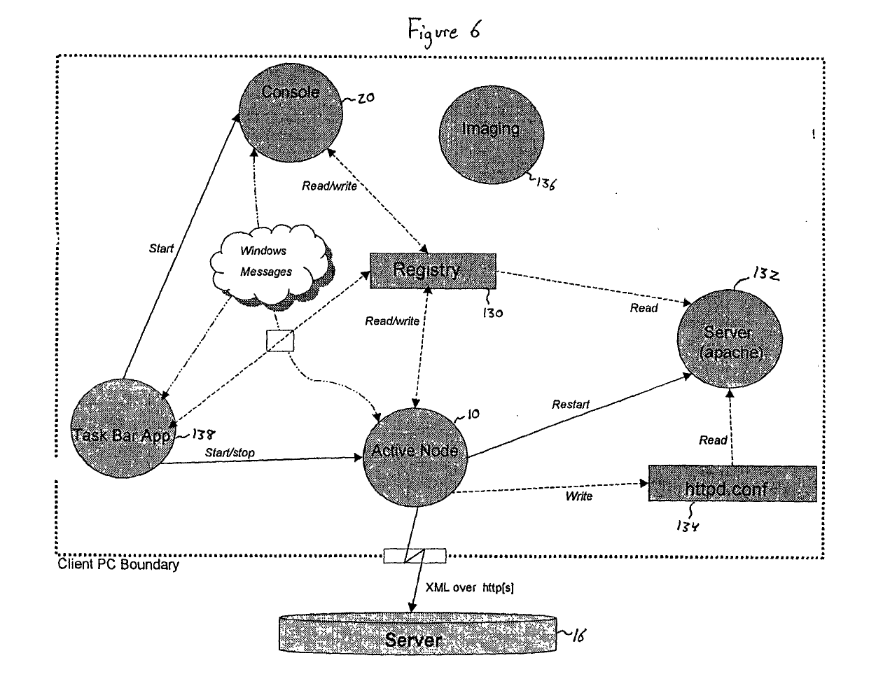

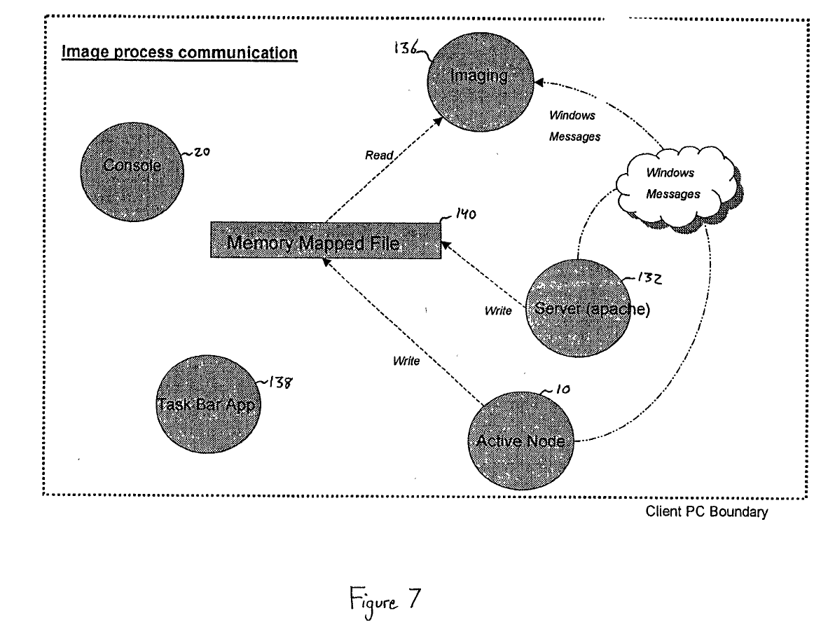

The inbound API 40 provides a partner with the ability to programmatically manage the registration, ongoing maintenance, and termination of end-user subscriptions. Preferably, the inbound API 40 may be comprised of three functions (however, additional functions may be incorporated and the above is exemplary). Exemplary functions include “AddSite” which creates a new end-user record at the server 16, “ModifySite” which updates an end-user record at the server 16, and “RemoveSite” which terminates an end-user's subscription (and removes an end-user record from the server 16). Associated exemplary data structures for these functions are shown in FIGS. 5A-5C.

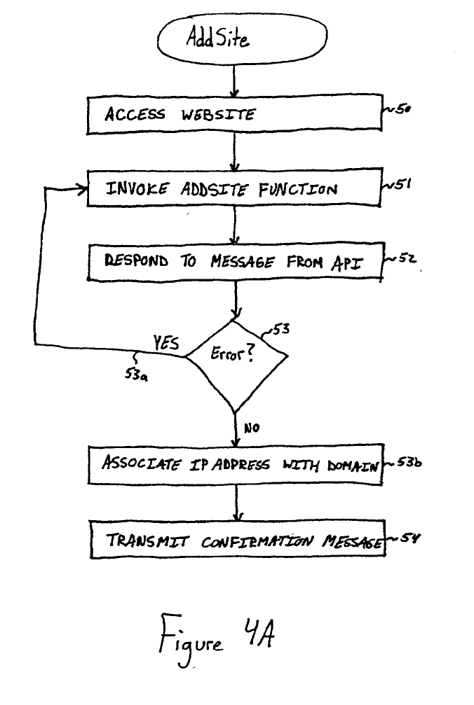

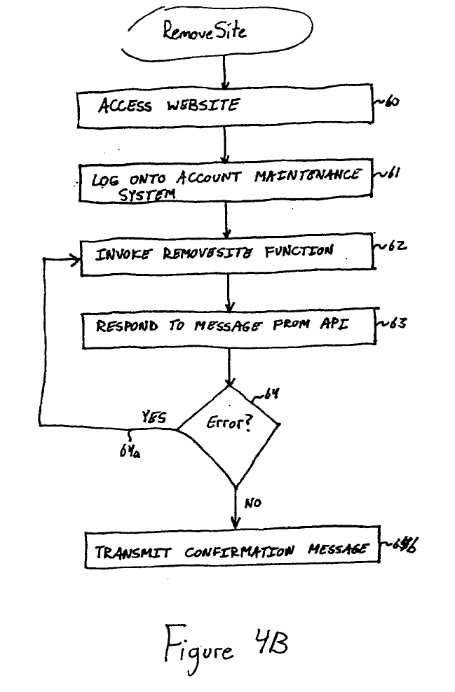

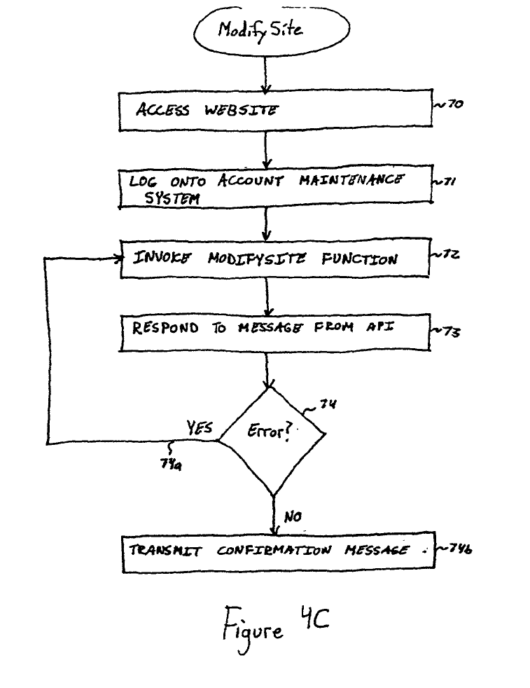

FIG. 4A illustrates operation of the inbound API 40 utilizing the “AddSite” function. As shown in FIG. 4A, an end-user may visit a partner's web site in search of a domain name and a hosting option, for example by accessing a website associated with the partner via the Internet (Step 50). The end-user may elect the service described herein and proceed to the registration process. Once the information is successfully gathered, the partner may transmit the end-user's information to the server 16, for example by invoking the “AddSite” function from the inbound API 40 (Step 51) which causes a particular message to be transmitted to the server 16 in order to create an end-user account by writing a record to its database. The server 16 may respond with an acknowledgement message, or alternatively, an error message if there is an error in receiving the information (Step 52). If an error is encountered, the “AddSite” function may again be invoked and a message may again be transmitted to the server 16 (FIG. 1) as described above (Step 53a). Otherwise, the partner may associate the IP address for the end-user's domain name to the server 16 (Step 53b), and the end-user may be presented with a confirmation web page (and/or an e-mail message) indicating to the end-user how to proceed with installation and configuration of the service (Step 54).

FIG. 4B illustrates operation of the inbound API 40 utilizing the “RemoveSite” function. As shown in FIG. 4B, an end-user may visit a partner's web site to cancel a previously made service subscription, for example by accessing a website associated with the partner via the Internet (Step 60). The end-user may log into an account maintenance section of the partner's web site and elect to cancel the subscription (Step 61). The cancellation request may be transmitted to the server 16 via the “RemoveSite” function (Step 62). The server 16 may respond with an acknowledgement message, or alternatively, an error message if there is an error in receiving the information (Step 63). If an error is encountered, the “RemoveSite” function may again be invoked and a message may again be transmitted to the server 16 as described above (Step 64a). Otherwise, the end-user may be presented with a web page acknowledging that the subscription has been canceled (Step 64b) (the end-user record may be removed from the server 16).

FIG. 4C illustrates operation of the inbound API 40 utilizing the “ModifySite” function. As shown in FIG. 4C, an end-user may visit a partner's web site, for example to update an associated account with a new e-mail address (other aspects of the account may be modified), such as by accessing a website associated with the partner via the Internet (Step 70). The end-user may log into an account maintenance section of the partner's web site and modify, for example, the subscriber's e-mail address (Step 71). The request may be transmitted to the server 16 via the “ModifySite” function (Step 72). The server 16 may respond with an acknowledgement message, or alternatively, an error message if there is an error in receiving the information (Step 73). If an error is encountered, the “ModifySite” function may again be invoked and a message may again be transmitted to the server 16 as described above (Step 74a). Otherwise, the end-user may be presented with a web page acknowledging that the e-mail address (or other) modification was successfully updated (Step 74b).

FIG. 5A illustrates an exemplary data structure 80 for the “AddSite” function. As shown, the data structure 80 may include a source field 81 which identifies a partner's unique identifier, a URL field 82 which identifies the domain name that is associated with an end-user, an accountID field 83 which is a user name used by the end-user, a subscriberEmail field 84 which identifies an e-mail address that is used to contact the end-user, and an accountname field 85 which identifies the end-user's given name in a freetext format. Optionally, the data structure 80 may include a pwd field 86 which identifies a password associated with the end-user's accountID (user name), a trialperiod field 87 which identifies a particular trial period time for using the service, and an affiliate field 88 that is used by the server 16 to determine branding and end-user ownership information.

FIG. 5B illustrates an exemplary data structure 90 for the “RemoveSite” function. As shown, the data structure 90 may include a source field 91 which identifies a partner's unique identifier, a URL field 92 which identifies the domain name that is associated with the end-user, and an accountID field 93 which is a user name used by the end-user. Optionally, the data structure 90 may include an affiliate field 94 that is used by the server 16 to determine branding and end-user ownership information.

FIG. 5C illustrates an exemplary data structure 100 for the “ModifySite” function. As shown, the data structure 100 may include a source field 101 which identifies a partner's unique identifier, a URL field 102 which identifies the domain name that is associated with an end-user, an accountID field 103 which is a user name used by the end-user, and a trialperiod field 104 which identifies a particular trial period time for using the service. Optionally, the data structure 100 may include an affiliate field 105 that is used by the server 16 to determine branding and end-user ownership information, a subscriberEmail field 106 which indicates that the end-user's preferred e-mail has changed, an accountname field 107 which indicates that the end-user's account name has changed, and a pwd field 108 which indicates that the end user's password has changed.

Returning to FIG. 3, the outbound API 42 enables partners to query end-user information stored in the server 16 (in a database), which may be used as input into various reporting, analysis, and sales activities. Preferably, the outbound API 42 may be comprised of a function for returning the total number of registered subscribers, a function for returning the total number of sites that have been activated with a specified time frame, a function for returning the total number of websites that have been converted from free sites to pay sites within a specified time frame, a function for returning the total number of websites that have been removed, abandoned, or have expired (collectively referred to as churns) within a specified time frame, a function for returning “report data” pertaining to the churns for a specified time frame and a specified billing type, a function for returning the number of invitation e-mails sent out to guests in a given time frame, a function for returning the average number of websites that have been registered per subscriber, a function for returning the total number of websites that have a specified version number, a function for returning the total number of guests that have visited particular websites within a specified period, a function for returning the total number of pages that have been rendered from a specific site within a specified period, a function for returning accumulated amount of data that has been served from a specific site within a specified time period, and a function for returning the number of subscribers using either a template view or a custom view to publish data. Other functions may be provided and the above are merely exemplary.

As discussed above, all communications between partners and the server 16 including the inbound API 40 and the outbound API 42, are secured via HTTPS (or other similar protocol), and are preferably bi-directionally authenticated through the use of Verisign certificates. Preferably, a Verisign certificate identifying the network operator is installed on the server 16 and the partner installs a Verisign Digital ID Certificate on its associated server, which is made known to the server 16 for authentication. Once the certificates have been respectively installed, communication between the partner and the server 16 may commence over HTTPS (or similar protocol) whereby the partner can authenticate the server and vice versa. Further, partners are provided with the ability to track the source of referrals that drive guests to register for the afforded service.

Returning to FIG. 1, the client application 10 allows subscribers to transform their own computer into a uniquely identifiable server, capable of publishing content over the public Internet. It communicates with the server 16 allowing discovery and resolution of domain names to a dynamically changing IP address. It also permits the subscriber to activate and configure the system as well as manage and publish the content. Activation allows the system to resolve domain names to dynamically changing IP addresses. For example, whenever the machine's IP address changes, this triggers an event which transmits and persists the new information in the database. This information is subsequently used by the guest module 32 (FIG. 2) which provides the lookup and redirect from a domain name to the appropriate IP address.

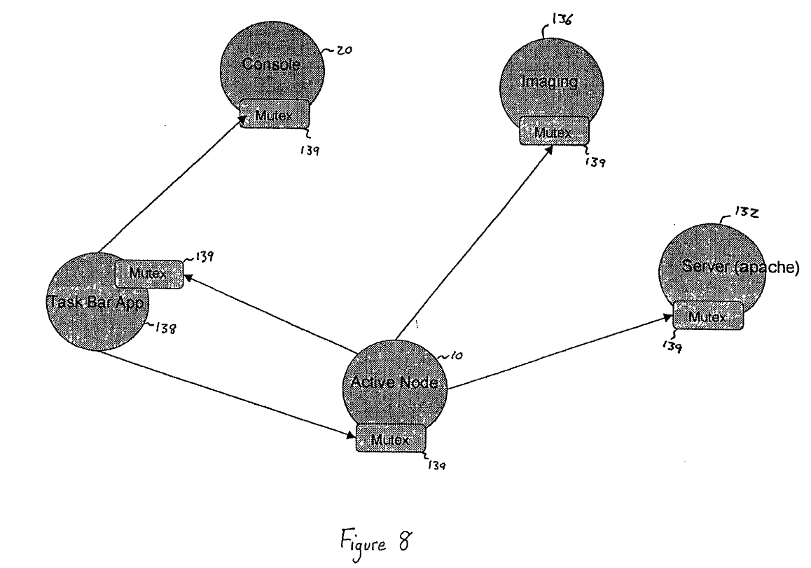

FIG. 6 is a diagram illustrating an architectural view of the client application 10 (FIG. 1). As shown in FIG. 6, the client application 10 communicates with the subscriber console application 20 via a software registry 130 to permit a subscriber to configure the system and manage content. The console application 20 allows the subscriber to initially activate the system and subsequently configure various portions of the system, for example via a series of configuration wizards. It also provides an interface to allow subscribers to manage content in a folder hierarchy as well as providing content annotation. The Active Node 10 is responsible for sending and receiving messages to/from the central server 16 as well as managing interaction with a standard Apache (or other) web server 132 instance that runs on the subscriber's computer. The Active Node 10 also manages communication via an XML messaging interface to the server 16. The subscriber console application 20 provides an intuitive graphical interface allowing the subscriber to activate and configure the system as well as manage content.

Still referring to FIG. 6, the interaction between the console application 20 and the Active Node 10 for supporting configuration of the system is illustrated. The configuration information is persisted on the subscriber's personal computer. Some of the configuration information (such as the virtual root folder) may be written to the Apache (or other) server 132 configuration file (httpd.conf) 134. Other information (such as private site password or list of guest e-mail addresses) may be placed in the operating system registry 130.

The system registry 130 is used as a data repository for all communication between the console application 20 and the Active Node 10. For example, to send a message to the Active Node 10, the console application 20 first places the data in the system registry 130, and transmits a message that is intercepted by the Active Node 10. Upon receipt of the message, the Active Node 10 reads the message data from the system registry 130 and acts upon that data. The Active Node 10 may send messages to the console application 20 in a similar fashion.

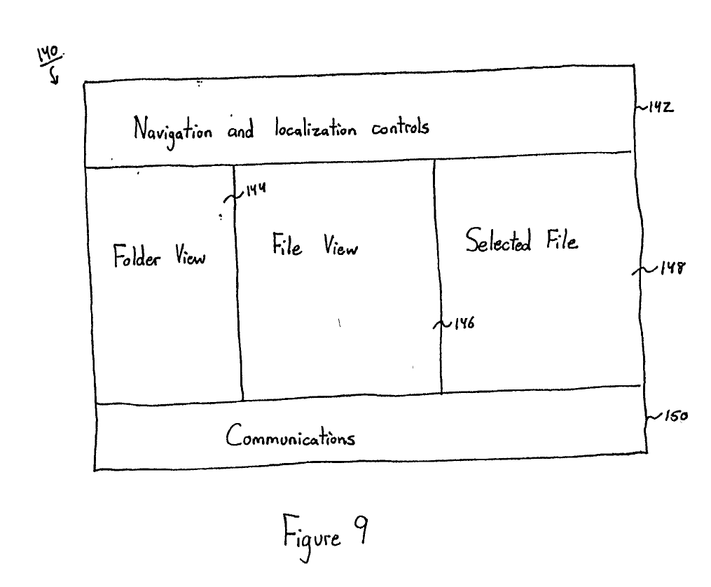

The imaging application 136 provides imaging functions such as thumbnailing, etc. FIG. 7 illustrates a communication scheme with the imaging application 136. As shown, communication with the imaging application 136 may occur using standard messaging techniques, such as Windows messaging as is well known in the art. Data may be passed to the imaging application 136 using a memory mapped file which promotes efficiency.

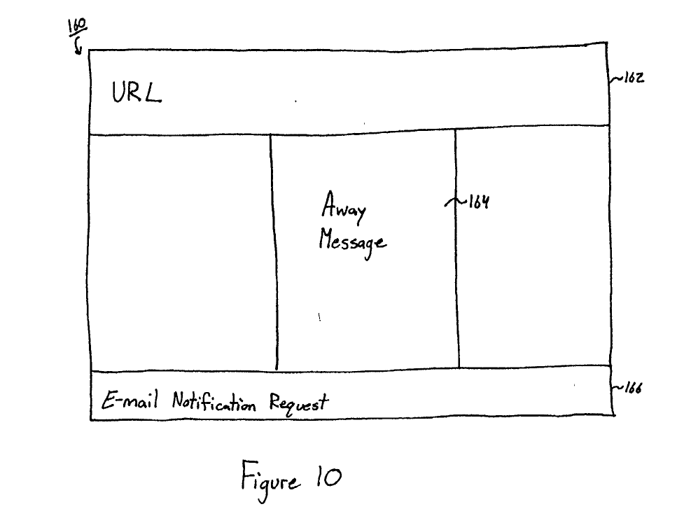

The console application 20, imaging application 136, server 132, Active Node 10, and task bar application 138 each create a mutex 139 which is used to ensure that the applications continue to run. This is shown in FIG. 8. Preferably, the task bar application 138 periodically checks the Active Node 10 to determine if it is running and will restart it if not running. Similarly, the task bar application 138 checks the console application 20 upon a user request and starts it if not running. The Active Node 10 preferably checks the task bar application 138 periodically to determine if it is running and restarts it if not running. The Active Node 10 also periodically checks the server 132 and imaging application 136 periodically and restarts them if not running. The mutexes are described in more detail below.

The registry 130 is used as the preferred central storage of configuration information for several reasons. Among them, it is unlikely that a user will delete data from the registry 130 (unlike standard configuration files that the user is more likely to delete). Additionally, the registry 130 normally will cache data for fast access, unlike files that require system overhead to open and read data. Further, there is only a small amount of data to be stored, and thus it is unlikely to encounter a size limitation with respect to storage. Also, the data is not directly visible to the user, and therefore the temptation to modify the configuration details is lessened significantly.

Upon initial installation of the client application 10, the Active Node 10 preferably automatically directs the console application 20 to prompt the subscriber to activate the web site. After the web site is activated, the Active Node 10 will direct the console application 20 to prompt the subscriber to configure the system. Configuration preferably consists of stating where the root folder for sharing content is located on the subscriber's hard drive, and determining whether the web site is public (open to all) or private (accessible via a password). Configuration also enables the subscriber to specify the text that they would like to have appear on the “Away” page. Once this configuration is complete, the subscriber is free to manage the content of the web site and the web site can be discovered by the DNS system.

Referring again to FIG. 6, the messaging interaction between the console application 20 and the Active Node 10 is shown. ACK/NACK messages are sent to the console application 20 from the Active Node 10 to provide it with updates to the status of requested operations. This allows for the console application 20 to be able to provide real-time feedback to the end-user. Exemplary ACK/NACK messages may include confirmation of activation, and confirmation/rejection of configuration changes.

In certain cases, the Active Node 10 may need to write or change entries into the Apache (or other) server's configuration file (httpd.conf) due to configuration changes within the system. In such case, the Active Node 10 writes changes (such as a change in the root directory) that are relevant to the Apache (or other) server 132 instance into the configuration file and the Apache (or other) server 132 is restarted to effectuate the changes. The Apache (or other) server 132 instance holds a mutex (a mutual exclusion object, a program object that allows multiple program threads to share the same resource, such as file access, but not simultaneously) to indicate that it is running. If the Apache (or other) server 132 instance fails, the mutex is released. Thus, the Active Node 10 can determine the status of the Apache (or other) server 132 instance by attempting to acquire the mutex. Preferable, the Active Node 10 checks the mutex every ten seconds, however, the time variant may be changed, for example, by the server 16.

Still referring to FIG. 6, a taskbar application 138 may be installed on the personal computer on system start-up. It allows a user to manually start and stop the Active Node 10. In operation, on start-up, the taskbar application 138 acquires a mutex. The Active Node 10 will check the taskbar application mutex periodically. Similarly, the taskbar application 138 periodically checks to see if the Active Node's mutex can be acquired. In either instance, if the respective mutex can be acquired than the respective application is restarted. Thus, the taskbar application 138 effectively checks on the “health” of the Active Node 10 and the Active Node 10 checks on the “health” of the taskbar application 138. In addition, the Active Node 10 also checks on the “health” of the server 132 (i.e., the server on the subscriber machine) and will restart the server 132 should it not be running.

Communication between the Active Node 10 and the server 16 is accomplished via XML over HTTP/S. XML provides flexibility, extensibility and structure to system messages. It is also used to enable multiple node versions to exist simultaneously on the network, thereby eliminating the need for subscribers to manually update node software.

The XML protocol used by the invention preferably consists of such messages as an Activation message, a Configuration message, a Notification message, a NodeAddressChange message, and a Ping message. The Activation message is sent from the Active Node 10 to the server 16 via a secure HTTPS connection to prevent eavesdropping. The Activation message is the first message that is sent from the Active Node 10 to bind a specific site to the server 16. Subsequently, any time the IP address of a subscriber's computer changes, the Active Node 10 notifies the server 16 of this change via the NodeAddressChange message.

The Configuration message is sent from the Active Node 10 to the server 16. It is used to transmit all configuration data from the subscriber console to the server. The Configuration message may contain the “away” message that a subscriber wishes to appear on the website when the subscriber's machine is disconnected from the Internet, or otherwise offline. It may also include an XML tag (PrivatePwd) if the site is private, and an XML tag (Emails) that represent the guests to whom the server 16 will send invitations.

The Notification message is sent from the Active Node 10 to the server 16. It sends the e-mail addresses of guests to whom various subscriber specified notification messages should be sent. The NodeAddressChange message is sent from the Active Node 10 to the server 16 to inform the server 16 that the IP address for the Action Node 10 has changed. The Ping message is preferably sent from the server 16 to the Active Node 10 each time a guest requests a page from the subscriber's site. It is used to determine whether a node is reachable or not, as it may be disconnected from the Internet, switched off, or merely sitting behind a firewall.

As discussed above, XML messages may be transmitted via HTTPS. The body of an HTTP request message is preferably comprised of a single name/value pair (xm1=[some xm1 string]). The contents of the XML string preferably conform to the following format: <?xm1 version=“1.0”?><EmbarkRequest><MsgType>[message data]</MsgType></EmbarkRequest>, where <?xm1 version=“1.0”?> precedes all XML strings and indicates the version of XML being used; <EmbarkRequest> is the enveloping XML tag indicating that this is a message adhering to a particular protocol of the system; <MsgType> is an inner XML tag that defines the actual message type; and [message data] is any valid XML string that contains the information pertaining to the contents of “MsgType.”

Similarly, the body of an HTTP response message is also preferably comprised of a single name/value pair (xm1=[some xm1 string]). The contents of the XML string preferably conform to the following format: <?xm1 version=“1.0”?><EmbarkResponse><MsgType>[message data]</MsgType></EmbarkResponse>, where <?xm1 version=“1.0”?> precedes all XML strings and indicates the version of XML being used; <EmbarkResponse> is the enveloping XML tag indicating that this is a message adhering to a particular protocol of the system; <MsgType> is an inner XML tag that defines the actual message type; and [message data] is any valid XML string that contains the information pertaining to the contents of “MsgType.”

A standard web browser (i.e., Internet Explorer, Netscape, etc.) is used to view the website of a subscriber. When a guest enters the URL of a subscriber's website into a browser, the request is handled by the server 16. Initial requests may occur over a non-secure connection. The guest module 32 (FIG. 2) in the server 16 resolves the mapping from the domain name to the subscriber's current IP address. If the subscriber's machine is currently online, the guest module 32 will redirect the request to the subscriber's computer. The redirect to the subscriber's website will also occur over a non-secure channel unless the subscriber has configured a private site, in which case the login transaction will occur over HTTP/S. If the subscriber's machine is found to be offline, the server 16 may display an “away page” notifying the guest to try again later.

The guest view provides a dynamically rendered presentation layer 22 (FIG. 1) to represent the subscriber's underlying shared files and folders. The guest view intelligently manages the presentation of various file types. Image file representations may be dynamically rendered as thumbnails that can be further displayed in full or as part of a slide show. Video and audio files are preferably presented with descriptive icons, ready to be activated by an embedded player or in full-screen mode.

A dynamic filtering mechanism is also implemented that is based on file types allowing users to contain the file types that are displayed at any given moment. Different filters are provided as part of the guest view and are represented by simple metaphors, i.e. “Photos”(for pictures, “Video”(for multimedia files), “Music”(for music), and “Other”(for miscellaneous files).

Preferably, the guest view is operational in different modes, such as Simple mode and Advanced mode. In the Simple mode, basic HTML templates may be provided that govern the layout of the screen. In the Advanced mode, subscribers may provide their own HTML code to govern the layout of the screen.

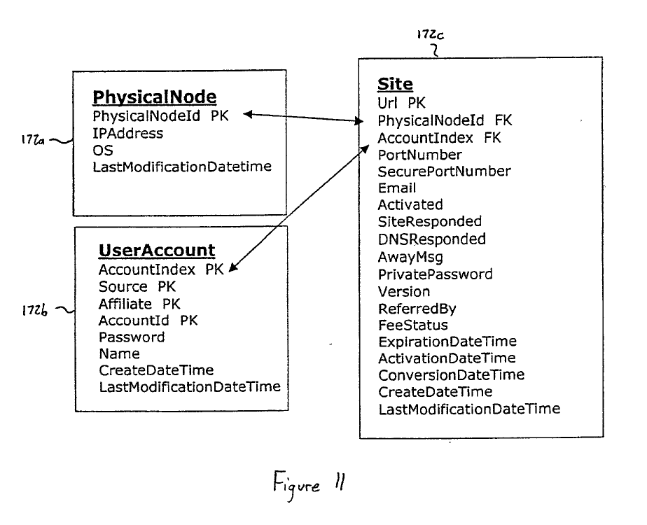

FIG. 9 is an exemplary representation of a screen layout 140 in accordance with the Simple mode of the presentation layer 22. As shown, the screen 140 may be apportioned into five (or other number) particular areas, a navigation and localization controls area 142, a folder view area 144, a file view area 146, a selected filed area 148, and a communications area 150. Preferably, the guest view runs in a Netscape, Microsoft, or AOL browser.

The navigation and localization controls area 142 of the screen may include a navigation pane (not shown) that a user may utilize to navigate particular (and other) subscriber web sites. The pane may include a home page area that may be indicated as text which serves as a dynamic link that returns the guest to the homepage indicated. The pane may also include MIME type filters that allow a guest to look for specific file types using the invention. Exemplary MIME type filter names may be, for example, “Photos” containing image files, such as .bmp, gif, jiff, jpe, jpeg, .png, tiff, tif, and .wmf files, “Movies” containing movie files, such as .asf, avi, .ivf, .mlv, .mp2 v, .mpe, .mpeg, .mpg, .mp2, .mpa, .wm, and .wmv files, “Audio” containing audio files, such as aif, .aifc, aiff, .au, .snd, .mid, midi, .rmi, .mp3, .wav, and .wma files, and “Miscellaneous” containing other file types, such as .pdf, .doc, .ppt, .xls, .htm, .html, and .txt files.

The pane may also include date/time information. Additionally, the pane may include a folder tree area that shows the currently viewed folder and all of its parent folders to allow a user to navigate through the various available folders in the folder tree. The pane may also include a MIME filter state that shows a currently selected filter option. The currently selected folder and file information may also be indicated in the pane.

The folder and file view areas 144, 146, 148 may list the subfolders available for review at a particular level in the folder tree, and the total number of files in a currently selected folder. Options such as pagination, and slideshow allow a guest to browse through content too numerous to fit in a single pane and allow guests to serially step through each file in the current directory, respectively. Selected files may be displayed in accordance with a format dependent on their MIME type. For example, image files may preferably be displayed as a medium sized thumbnail of the image. A user may select the image to view its full size. Movie and music clips may preferably be displayed embedded in a media player. Other file types may preferably be displayed as thumbnails of the first page of the respective file. Selecting such an icon may render the full file in a separate browser window. The details regarding the displayed file may also be indicated.

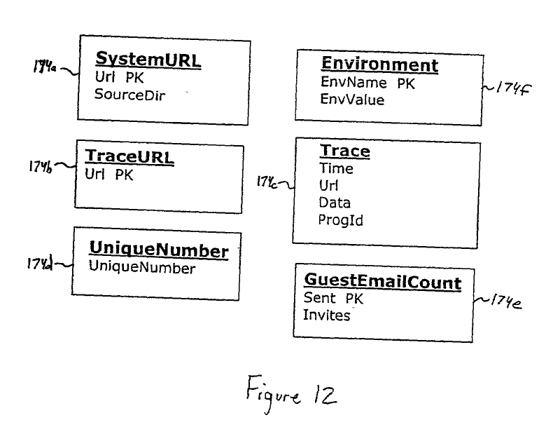

As discussed above, when a subscriber is not presently on-line, the system may display an “Away” page to a guest attempting to access the subscriber's site. FIG. 10 is an exemplary representation of an away page 160 that may be displayed. The away page may be apportioned into different areas, such as an URL area 162, an away message area 164, and a communications area 166.

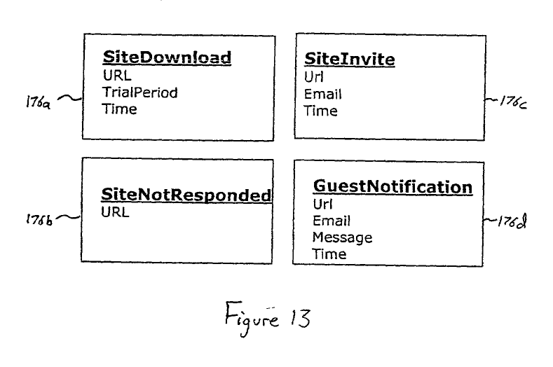

FIGS. 11-13 respectively illustrate an exemplary database schema 170 that may be used by the system to facilitate information storage. In FIG. 11, three primary tables 172a, 172b, 172c are illustrated, however, there may be additional tables provided and these are merely exemplary. Table 172a (PhysicalNode) represents information about the subscriber's personal computer. Table 172b (UserAccount) captures information pertaining to the “account owner.” An account is a billing entity and may correspond to an account with a registrar or ISP. Table 172c (Site) captures information pertaining to the web site itself. A web site is a manifestation of a URL on the subscriber's personal computer.

FIG. 11 also shows the relationship between tables 172a, 172b, 172c. For example, the relationship between table 172b (UserAccount) and table 172c (Site) is a one-to-many relationship. That is, many web sites may be serviced under the same account. The relationship between table 172c (Site) and table 172a (PhysicalNode) is a many-to-one relationship. That is, many web sites may be serviced under the same account.

FIG. 12 illustrates exemplary system tables 174a, 174b, 174c, 174d, 174e, 174f that may be used with the database schema. Table 174a (SystemURL) contains one or more URLs that are product site URLs rather than subscriber URLs. These can be thought of as nonsubscriber URLs. For example, the URL www.flipstream.com would be a system URL, as could the absolute IP address of the server. This table 174a enables system URLs to be changed without pausing the server 16.

Table 174b (TraceURL) may be populated at run time with the URLs that require tracing. For example, suppose a subscriber with the URL www.mjefry.com is having difficulties using the system. An operator at a help desk for assisting that subscriber may switch on tracing for that URL which causes certain diagnostics to be written to table 174c (Trace) (described below).

Table 174c (Trace) contains both tracing information for URLs that have been switched on via table 174b (TraceURL), plus error messages. The URL field represents the subscriber's site for which a request was made. The data field is the trace or error message, and the ProgId field is the identifier for the component that wrote the trace message.

Table 174d (UniqueNumber) is an ancillary table that is used to generate a unique “seed” number for the UserAccount table's AccountIndex field (table 172b, FIG. 11).

Table 174e (GuestEmailCount) contains a count of the number of emails sent to guests on a specific day. The sent field indicates the date for which the invites field pertains. The invites field indicates the number of invites sent.

Table 174f (Environment) contains name/value pairs used for system configuration. The table can be modified at any time, but new settings are generally read when the server 16 is restarted. Some exemplary name/value pairs include TraceEnabled (a system level switch to turn on/off tracing), MessageTimeout (number of seconds that the server waits for a node response), and DownloadLink (the current link to the node install software), and ProductName (the name of the product).

Security tables may also be provided. An exemplary security table (not shown) may contain the common name and issuer of the client certificates that will be accepted by a server. Archive tables may be used when a site is removed or when an account is removed.

FIG. 13 illustrates exemplary e-mail daemon system tables 176a, 176b, 176c, 176d that may be used with the database schema. Table 176a (SiteDownload) indicates entries pertaining to subscribed users of the system. Preferably, the e-mail daemon 34 will send an e-mail to all subscribers indicated in the table 176a, and will then remove the subscriber from the table 176a. The e-mail message may contain a hyperlink back to a provisioning website, so that the subscriber can download appropriate client node software 10. The URL field indicates an identifier for a new website. The TrialPeriod field indicates whether the site will expire after a period of time. The Time field indicates time information when the entry was written into the database.

Table 176b (SiteNotResponded) indicates whether the e-mail daemon was successful in contacting a particular client node. In the event an unsuccessful attempt is encountered, it is likely that the client node resides behind a firewall, and an appropriate entry is made into the table 176b. The e-mail daemon 34 subsequently uses this information to send a message to the subscriber, informing that their node is unreachable, and is most probably sitting behind a firewall. After sending the message, the database entry may be removed.

Table 176c (SiteInvite) indicates an identifier of an invitee that a subscriber wishes to have visit his or her website. The e-mail daemon sends an e-mail to all guests in this table 176c informing them that they have been invited to view a new website. The identifier entry may then be removed from the table 176c. The URL field indicates the identifier for the website. The Email field indicates an e-mail address for a guest. The time field indicates time information as to when the entry was written into the database.

Table 176d (GuestNotification) indicates entries of selected guests with whom a subscriber wishes to send a text message. Accordingly, those guests' e-mail addresses are entered into the table 176d. The e-mail daemon 34 sends an e-mail to the guests indicated in the table 176d, thereby sending them the desired text message. After sending the text message, the entries may be deleted from the table 176d. The URL field indicates the identifier for the website. The e-mail field indicates an e-mail address for a particular guest. The message field indicates the message to be sent to a guest. The time field indicates time information when the entry was written into the database.

The present invention thus provides a data driven approach to system messaging that allows new tasks and data structures to be added to the system at run-time, rather than at compile time. This design also serves to provide backward compatibility allowing a single instance of the server to transparently support multiple versions of deployed client software. The system can handle multiple subscriber accounts with multiple domain names across multiple node computers.

The system is designed to be dynamically configurable, providing flexibility, without the need for recompilation. Certificate information, branding and e-mail hyperlinks are just a few of the server side variables that can be configured at run-time by operators of the service.

The system also utilizes various levels of security throughout depending on the nature of the interactions, parties involved, and data being transmitted. For example, SSL and certificates may be used to respect user privacy, authenticate partner identities and provide a secure end-to-end connection for the transmission of sensitive information.

The modular nature of the system also allows for natural separation of component level functionality across many servers. In addition, new components may be added and existing components re-used or replaced without impacting the rest of the system. Further, the system is designed to be inherently scalable in many dimensions. The processing engines are preferably stateless so that they may simply pull the next piece of work from a queue of tasks. New engines may be added to the system to achieve linear scaling. In addition, the server may use a model similar to DNS, where individual or groups of subscribers may be directed to a specific server bank, i.e., subscriber IP addresses can be pointed at one of several machines. Due to its stateless nature, multiple servers may be used with load balancing hardware/software to provide a simple round robin distribution of processing power. Database servers may also be clustered to optimize performance.

While the foregoing has been described with reference to particular embodiments of the invention, such as a dynamic file sharing system, it will be appreciated by those skilled in the art that changes in these embodiments may be made without departing from the principles and spirit of the invention.

What is claimed is:

1. A system for publishing information content over a network comprising:
one or more subscriber computers connected to a server via the network, each of the subscriber computers having a client application residing thereon for managing communication between the respective subscriber computer and the server, and a console application for enabling the serving of information from the respective subscriber computer such that the information is accessible via a standard web browser application, and the server having one or more APIs residing thereon for managing end-user information received from the subscriber computers.

2. The system of claim 1, wherein the APIs further manage end-user information received from a managing service provider.

3. The system of claim 1, further comprising a presentation layer for dynamically generating a webpage that is displayed in the web browser application and has actively managed hyperlinks to the information located on the respective subscriber computers.

4. The system of claim 1, wherein the subscriber computers are connected with the server via the Internet.

5. The system of claim 1, wherein the availability of the information is restricted to a community of designated individuals.

6. The system of claim 1, wherein the published information includes any of image files, movie files, audio files, and documents.

7. The system of claim 1, wherein communication between the subscriber computers and the server is accomplished via HTTP/S over the Internet.

8. The system of claim 7, wherein an XML messaging scheme is used to manage communications between the client application and the server.

9. The system of claim 8, wherein the XML messaging scheme includes a first message transmitted from the client application to the server for informing the server that an associated website is active, a second message for informing the server of the IP address of a subscriber computer, a third message transmitted from the client application to the server for transmitting configuration information to the server, a fourth message transmitted from the client application to the server for sending e-mail addresses of guests to whom various notification messages should be sent when a website is online, and a fifth message transmitted from the server to the client application to determine whether the client application is reachable.

10. The system of claim 1, wherein the server comprises a subscriber module for communicating with the client application, a guest module for processing requests originating from the web browser application, a management API module for providing a secure interface between a partner computer and the server, and one or more daemon applications for managing communications among one or more subscribers and guests.

11. The system of claim 10, wherein the guest module resolves a domain name to a current IP address of a subscriber computer, and monitors the subscriber computers to determine which of the subscriber computers are online, and if online, redirects a computer originating the request to the appropriate subscriber computer.

12. The system of claim 10, wherein the guest module handles subsequent requests originating from the web browser application and redirects such requests to the appropriate subscriber computer.

13. The system of claim 12, wherein the subsequent requests are hyperlink selections.

14. The system of claim 10, wherein the guest module causes an away webpage to be displayed in the web browser application when the subscriber computer attempted to be accessed is offline.

15. The system of claim 10, wherein the management API module permits the creation and management of subscriber account information.

16. The system of claim 10, wherein the daemon applications handle e-mail traffic generated by either of subscriber actions and management API module requests.

17. The system of claim 16, wherein the daemon applications perform any of generating HTML e-mails with appropriate branding information, sending e-mail messages on behalf of a particular subscriber, generating private web site invitations, and sending e-mail notification messages.

18. The system of claim 10, wherein the management API module comprises an inbound API module for enabling the creation, modification, and deletion of end-user record information, an outbound API module for permitting querying of the system, and a security and authentication module for authenticating communications within the system.

19. The system of claim 18, wherein the inbound API module includes a first function for creating a new end-user record, a second function for updating an end-user record, and a third function for removing an end-user record.

20. The system of claim 19, wherein the first function comprises a data structure having a first field for identifying a unique identifier of a partner, a second field for identifying the domain name associated with an end-user, a third field for identifying a user name associated with an end-user, a fourth field for identifying an e-mail address associated with an end-user, and a fifth field for identifying a given name of an end-user.

21. The system of claim 20, wherein the data structure has a sixth field for identifying a password associated with an end-user, a seventh field for identifying a trial period timeframe, and an eighth field for determining branding and end-user ownership information.

22. The system of claim 19, wherein the second function comprises a data structure having a first field for identifying a unique identifier of a partner, a second field for identifying the domain name associated with an end-user, and a third field for identifying a trial period timeframe.

23. The system of claim 22, wherein the data structure has a fourth field for determining branding and end-user ownership information, a fifth field for indicating whether a preferred e-mail address for an end-user has changed, a sixth field for indicating whether an account name for an end-user has changed, and a seventh field for indicating whether a password for an end-user has changed.

24. The system of claim 19, wherein the third function comprises a data structure having a first field for identifying a unique identifier of a partner, a second field for identifying the domain name associated with an end-user, and a third field for identifying a user name associated with an end-user.

25. The system of claim 24, wherein the data structure has a fourth field for determining branding and end-user ownership information.

26. The system of claim 18, wherein the outbound API module includes a first function for returning the number of registered subscribers of the system, a second function for returning the number of activated sites, a third function for returning the number of converted sites, a fourth function for returning the number of churns, and a fifth function for returning the number of invitation messages sent to one or more guests.

27. The system of claim 26, wherein the outbound API further includes a sixth function for returning the average number of registered websites, a seventh function for returning the number of guests that visited particular websites, an eighth function for returning the total pages rendered from a specific website, and a ninth function for returning an accumulated amount of data served from a specific website.

28. The system of claim 1, wherein the client application communicates with the console application via a software registry which permits configuration of the system and management of content.

29. The system of claim 28, wherein configuration information is persisted on the subscriber computer and a portion of the configuration information is written to a configuration file associated with an instance of a server running in the subscriber computer.

30. The system of claim 29, wherein the instance of a server is an instance of an Apache server.

31. The system of claim 29, wherein a sync file is used to notify the client application of a change in state of the registry, such that the client application responds to the notification from the sync file to read the system registry and process the configuration changes.
